(19) United States
(12) Patent Application Publication
(10) Pub. No.: US 2010/0162139 A1
(43) Pub. Date: Jun. 24, 2010

(54) MULTI-FUNCTION STATUS INDICATOR FOR CONTENT RECEIPT BY A MOBILE COMPUTING DEVICE

(75) Inventors: Matthew Beebe, Sunnyvale, CA (US); Jeremy Lyon, Sunnyvale, CA (US); Matias Duarte, Sunnyvale, CA (US)

Correspondence Address: FENWICK & WEST LLP, SILICON VALLEY CENTER, 801 CALIFORNIA STREET, MOUNTAIN VIEW, CA, 94041, US

(73) Assignee: PALM, INC., Sunnyvale, CA (US)

(21) Appl. No.: 12/397,319

(22) Filed: Mar. 3, 2009

Related U.S. Application Data
(60) Provisional application No. 61/139,525, filed on Dec. 19, 2008.

(51) Int. Cl. G06F 3/00

(52) U.S. Cl. 715/760

(57) ABSTRACT

A system and a method are disclosed for regulating receipt of content by a mobile computing device. A status indicator is generated and used to describe whether content has been received or is currently being received. An interaction with the status indicator while content is being received causes stops receipt of content by the mobile computing device. After content has been received, an interaction with the status indicator transmits a request to a remote device, such a server, to update the content previously received by the mobile computing device. The visual appearance of the status indicator can also be modified to indicate whether data is currently being received or has been received.

### CROSS REFERENCE TO RELATED APPLICATIONS

This application claims the benefit, under 35 U.S.C. §119(e), of U.S. Provisional Application No. 61/139,525, filed Dec. 19, 2008, which is incorporated by reference in its entirety.

### FIELD OF ART

The disclosure generally relates to the field of content retrieval by a mobile computing device and, more particularly, to regulating content retrieval and preserving display resources of a mobile computing device.

### DESCRIPTION OF THE RELATED ART

Mobile computing devices are becoming increasingly more powerful and functional devices. Many mobile devices are multifunction devices with multiple roles, such as personal digital assistant (PDA), smart phone, cellular phone, portable media player, web browser, voice recorder, video recorder, global positioning system (GPS), camera and electronic file storage. This increased functionality has resulted in mobile computing devices being used to manage appointments, tasks, contacts, access web sites and perform other tasks where content, such as web pages, calendar information, email, task lists, contact listing or other information, is exchanged between the mobile computing device and a server or other data source. The portability of mobile computing devices allows these tasks to be performed from multiple locations, allowing users greater access to content.

However, the compact size of most mobile devices limits the screen size available for displaying content. Conventional mobile devices further limit amount of data displayed by also allocating screen resources for display of navigation commands rather than received content. For example, a web browser allocates portions of the screen for navigation commands, such as “back,” “forward,” “cancel loading” and “refresh,” which, respectively, allow a user to view the previously loaded web page, view a more recently viewed web page, stop retrieving a web page from a server or other data source and update the data associated with the currently viewed web page. Hence, the limited screen size of the mobile computing device is further reduced by displaying navigation commands. Further, these navigation commands commonly remain visible, but presented as inactive, even when they are not applicable. For example, the “cancel loading” command is displayed even after a web page completely loads, even though the “cancel loading” command does not affect a loaded web page. This persistent display of inapplicable navigation commands further reduces the screen area available for display of content.

### SUMMARY

One embodiment of a disclosed method for regulating receipt of content by a mobile computing device generates a status indicator and determines whether content is being received by the mobile computing device. The status indicator describes whether content has been received or is being received. Responsive to receiving an interaction with the status indicator while content is being received, the mobile computing device stops receipt of the content, allowing control of content receipt using the status indicator. Responsive to an interaction with the status indicator after content has been received, a request to update the content is transmitted, allowing the status indicator to initiate receipt of a more recent version of previously received content. The visual appearance of the status indicator can also be modified to indicate whether data is currently being received or has been received. For example, during receipt of content, the status indicator displays a symbol or text associated with stopping receipt of content and after receipt of content the status indicator displays a symbol or text associated with updating content. In this way, the functions of a “stop” button, a “refresh” button, and a page download status bar for a web browser application are combined into a single user interface element on a display screen of a portable communication device having limited real estate.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying drawings, in which:

FIG. 1 illustrates one embodiment of a mobile computing device.

FIG. 2 illustrates one embodiment of an architecture of a mobile computing device.

FIG. 3A illustrates one embodiment of a status indicator performing a first function.

FIG. 3B illustrates one embodiment of a status indicator modified to perform a second function.

FIG. 4 illustrates one embodiment of a state diagram for modifying a status indicator according to receipt of content.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Mobile Computing Device

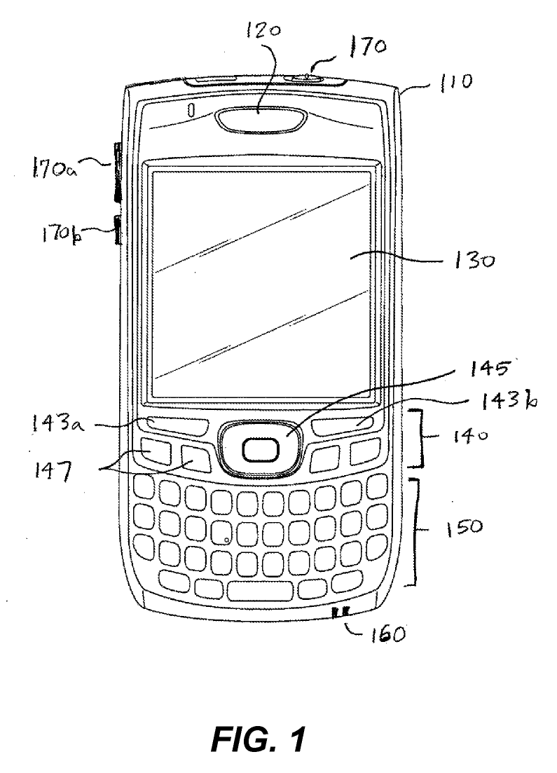

FIG. 1 illustrates one embodiment of a mobile computing device 110 with telephonic functionality, e.g., a mobile phone or a smartphone. The mobile computing device is configured to host and execute a phone application for placing and receiving telephone calls. It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) or data networks having voice over internet protocol (VoIP) functionality.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 12.75 centimeters in width, 0.64 to 2.2 centimeters in height and weigh between 50 and 250 grams.

The mobile computing device 110 includes a speaker 120, a screen 130, a navigation area 140, a keypad area 150, and a microphone 160. The mobile computing device 110 also may include one or more switches 170, 170a, 170b (generally 170). The one or more switches 170 may be buttons, sliders, or rocker switches and can be mechanical or solid state (e.g., touch sensitive solid state switch).

The screen 130 of the mobile computing device 110 is, for example, a 240×240, a 320×320, or a 320×480 transflective display. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The navigation area 140 is configured to control functions of an application executing in the mobile computing device 110 and visible through the screen 130. For example, the navigation area includes an x-way (x is a numerical integer, e.g., 5) navigation ring 145 that provides cursor control, selection, and similar functionality. In addition, the navigation area 140 may include selection buttons 143a, 143b to select functions viewed just above the buttons on the screen 130. In addition, the navigation area 140 also may include dedicated function buttons 147 for functions such as, for example, a calendar, a web browser, an e-mail client or a home screen. In this example, the navigation ring 145 may be implemented through mechanical, solid state switches, dials, or a combination thereof. The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard). In other embodiments, the keypad area 150 is a sliding keypad area which may retract to a position posterior to the screen 130.

Although not illustrated, it is noted that the mobile computing device 110 also may include an expansion slot. The expansion slot is configured to receive and support expansion cards (or media cards), which may include memory cards such as CompactFlash™ cards, SD cards, XD cards, Memory Sticks™, MultiMediaCard™, SDIO, and the like.

### Example Mobile Computing Device Architectural Overview

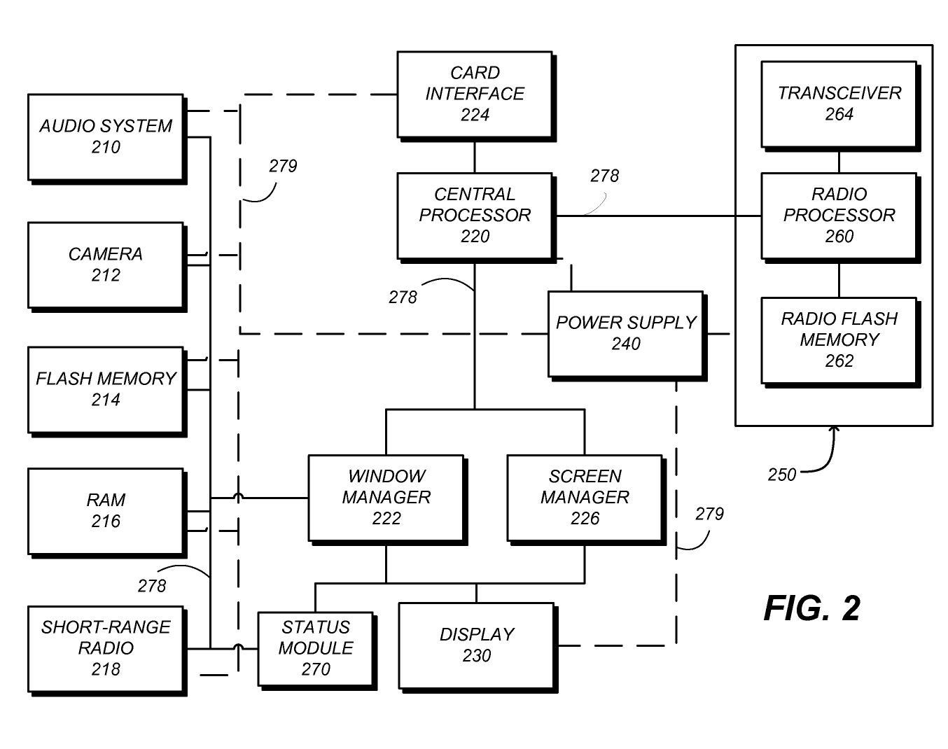

Referring next to FIG. 2, a block diagram illustrates one embodiment of an architecture of a mobile computing device 110, with telephonic functionality. By way of example, the architecture illustrated in FIG. 2 will be described with respect to the mobile computing device of FIG. 1. The mobile computing device 110 includes a central processor 220, a power supply 240, and a radio subsystem 250. The central processor 220 communicates with: audio system 210, camera 212, flash memory 214, RAM memory 216, short range radio module 218 (e.g., Bluetooth, Wireless Fidelity (WiFi) component), a window manager 222 and a screen manager 226. The central processor communicatively couples these various components or modules through a data line (or bus) 278. The power supply 240 powers the central processor 220, the radio subsystem 250 and a display driver 230 (which may be contact- or inductive-sensitive). The power supply 240 may correspond to a direct current source (e.g., a battery pack, including rechargeable) or an alternating current (AC) source. The power supply 240 powers the various components through a power line (or bus) 279.

In one embodiment, the window manager 222 comprises a software or firmware process that initializes a virtual display space stored in the RAM 216 and/or the flash memory 214. The virtual display space includes one or more applications currently being executed by a user and the current status of the executed applications. The window manager 222 receives requests, from user input or from software or firmware processes, to show a window and determines the initial position of the requested window. Additionally, the window manager 222 receives commands or instructions to modify a window, such as resizing the window, moving the window or any other command altering the appearance or position of the window, and modifies the window accordingly.

The screen manager 226 comprises a software or firmware process that manages content displayed on the screen 130. In one embodiment, the screen manager 226 monitors and controls the physical location of data displayed on the screen 130 and which data is displayed on the screen 130. The screen manager 226 alters or updates the location of data as viewed on the screen 130. The alteration or update is responsive to input from the central processor 220 and display driver 230, which modifies appearances displayed on the screen 130. In one embodiment, the screen manager 226 also monitors and controls screen brightness and transmits control signals to the central processor 220 to modify screen brightness and power usage to the screen 130.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

The status module 270 comprises software or firmware instructions for execution by the central processor 220 which monitor receipt of content by the short range radio 218 and modify the display driver 230 accordingly. While the short-range radio 218 is receiving content, the status module 270 communicates with the window manager 222 and/or the screen manger 226 via data line 278 to present a status indicator on the screen 130 using the display driver 230. The status indicator notifies a user that content is being currently downloaded by the short-range radio 218. During the downloading, the status indicator may also display an indication of the progress of the downloading (e.g., an icon that fills corresponding to the percentage of the downloading that has been completed). Additionally, while content is being retrieved, interaction with the status indicator cancels retrieval of the content. For example, interacting with the status indicator allows a user to stop receipt of a web page from a server or other data source.

When the short-range radio 218 has completed receipt of content, the status module 270 is notified that the content has been received and communicates with the window manager 220 and screen manger 226 to modify the status indicator presented on the screen 130 via display driver 230. This allows the status indicator to notify a user that receipt of content has completed. Additionally, interaction with the modified status indicator allows a user to transmit a request for a more recent version of the content currently displayed on the screen 130 (e.g., the functionality of a refresh button in a browser application). Hence, the status module 270 allows a single status indicator to both cancel receipt of content and refresh previously received content, depending on whether content has been received or is currently being received.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) mobile, High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using the data line (or bus) 278.

The card interface 224 is adapted to communicate with the expansion slot. The card interface 224 transmits data and/or instructions between the central processor and an expansion card or media card included in the expansion slot. The card interface 224 also transmits control signals from the central processor 220 to the expansion slot to configure an expansion card or media card included in the expansion slot.

In one embodiment, central processor 220 executes logic (by way of programming, code, instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment.

### Example Multi-Function Status Indicator Implementation

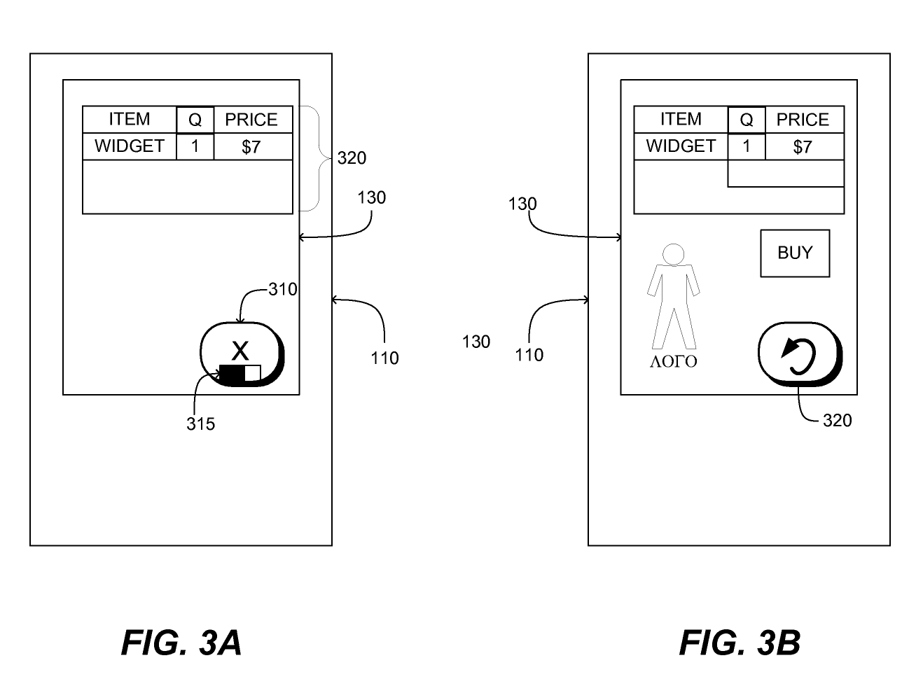

FIG. 3A illustrates one embodiment of a status indicator performing a first function. As shown in FIG. 3A, portion 320 of the web page that has been received by the mobile computing device 110 is displayed while the remainder of the web page is being received; however, in other embodiments, the content being loaded in displayed on the screen 130 takes different forms, such as a calendar, a contact list, a task list or other data retrieved from a remote source. Alternatively, the screen 130 displays a message or other indicator that the web page is being loaded.

As the web page, or other content, is being received by the mobile computing device 110, interaction with the status indicator 310 allows retrieval of the web page, or other content, to be stopped. In one embodiment, the status indicator 310 visually indicates that interaction with the status indictor 310 stops retrieval of content. For example, as shown in FIG. 3A, the status indicator 310 displays an “X,” a stop sign image, the word “cancel” or other symbol or text associated with stopping retrieval of content to visually depict the result of interaction with the status indicator 310.

In one embodiment, the status indicator 310 also displays a progress indicator 315 which visually depicts an amount of content that has been received relative to a total amount of content, allowing the status indicator 310 to display the percentage of the content that has been received. For example, the progress indicator 315 is a rectangular region representing the overall content that is shaded or otherwise visually modified as portions of the content are received, providing a visual estimate of the percentage of the content that has been received. Alternatively, the progress indictor 310 comprises a numeric display of the percentage of content that has been received. In another embodiment, the progress indicator 315 is implemented using the background shading or coloring of the entire status indicator 310 itself, where the status indicator 310 fills up (e.g., top to bottom, side to side, radially outward, or circumferentially like a clock) as the content is downloading.

FIG. 3B illustrates one embodiment of a status indicator 320 in a different state to perform a second function. For illustration, FIG. 3B shows a fully-loaded web page displayed on the screen 130, and the second function of the status indicator 320 is to refresh a currently viewed web page. However, in other embodiments, the content displayed on the screen 130 takes different forms, such as a calendar, a contact list, a task list or other data retrieved from a remote source.

After the web page, or other content, has been fully received by the mobile computing device 110 and displayed on the screen 130, the status indicator 320 allows updating of the web page, or other content displayed. In one embodiment, the status indicator 320 visually indicates that interaction with the status indictor 320 updates previously received content. For example, as shown in FIG. 3B, the status indicator 320 displays a refresh icon or other symbol or text associated with refreshing or updating content to show that interaction with the status indicator 320 to visually indicate that interaction with the status indicator 320 retrieves an updated version of the previously received content.

In one embodiment the status indicator 310, 320 comprises a region on a touch-sensitive display which receives interaction through contact with the region of the touch-sensitive display. Alternatively, the status indicator 310, 320 comprises a soft button that receives interaction through activation of a physical switch of the mobile computing device 110 proximate to the status indicator 310, 320.

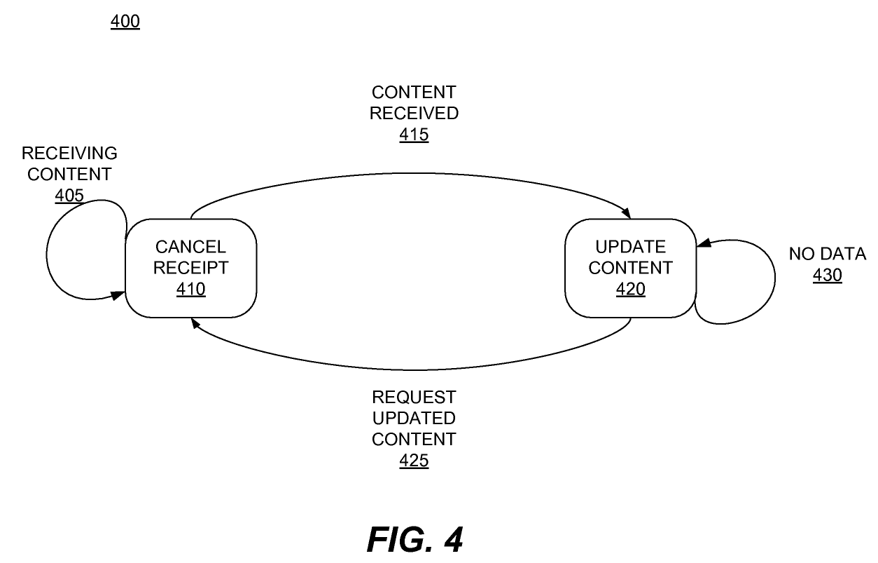

FIG. 4 illustrates one embodiment of a state diagram 400 for modifying a status indicator responsive to receipt of content. In an embodiment, the states and state transitions depicted in the state diagram 400 of FIG. 4 are implemented by instructions for performing the described actions are embodied or stored within a computer readable medium, e.g., flash memory 214 or RAM 216, that are executable by a processor, such as central processor 220. Those of skill in the art will recognize that the state diagram 400 may be implemented in embodiments of hardware and/or software or combinations thereof. Moreover, other embodiments can include different and/or additional states or state transitions than the ones shown in FIG. 4.

When content is being received 405 by the short range radio module 218, the status indicator 310 is constantly updating its indication of the progress, as described above. While in this state, a user interaction with the status indicator 310 cancels receipt 410 or stops downloading of the content. In one embodiment, the status indicator also visually displays an indication of the percentage of content already received. Additionally, the status indicator may visually indicate that interaction with the status indicator stops receipt of content by displaying a symbol or text associated with stopping or halting an action.

Upon complete receipt 415 of the content, interaction with the status indicator is used to update 420 the received content by requesting a more recent version of the received content. Hence, interaction with the status indicator after receipt 415 of content causes the mobile computing device 110 to request 425 updated content via the short range radio module 218. While content is not received 430, interaction with the status indicator causes updating 420 of received content with a more recent version. Additionally, the status indicator may visually indicate that interaction with the status indicator requests an updated version of the previously received content by displaying a symbol or text associated with refreshing or updating content. Alternatively, while content is not received 430, the status indicator is hidden to further increase the amount of the screen 130 used to display content; responsive to a user interaction with the screen 130 or keypad area 150, the status indicator visually displayed on the screen 130. Subsequent interaction with the status indicator allows retrieval of updated content.

For example, after receiving 415 a complete web page, interaction with the status indicator refreshes the web page by requesting 425 an updated version of the web page from a web server or other source. During receipt 405 of the updated version of the web page, interaction with the status indicator cancels 410 receipt of the updated version of the web page. This allows a single status indicator for both initiating receipt of content and canceling receipt of content, enabling a larger amount of the screen 130 to be used for displaying the web page or other received content rather than for displaying navigation or other commands. Allowing a single status indicator to opeate in multiple states conserves display resources while simplifying user intercation with or navigation through content received by the mobile computing device.

In contrast, conventional methods for displaying and navigation received content decrease the amount of the screen 130 available for displaying content, such as web pages. As interfaces are conventionally displayed for updating received content and canceling receipt of content, more screen area is allocated for display of commands. This reduction in screen area for content display also increases the amount of user interaction with the mobile computing device 110 necessary to view content. For example, displaying separate update and cancel commands requires users to more frequently scroll through the content to compensate for the screen area used to display the update and cancel commands.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for regulating content retrieval on a mobile computing device through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A computer readable storage medium configured to store instructions, the instructions when executed by a processor cause the processor to execute the steps of:
downloading a web page over a network;
during the downloading, displaying a user interface element showing progress of the downloading;
upon completion of the downloading, modifying the user interface element to indicate completetion of the downloading; and
responsive to a user selection of the user interface element after completion of the downloading, requesting a refresh of the web page.

2. The computer readable storage medium of claim 1, further comprising the step of:
responsive to a user selection of the user interface element during the downloading, canceling the downloading.

3. The computer readable storage medium of claim 1, wherein showing progress of the downloading comprises:
visually modifying the user interface element responsive to storing a portion of the web page to provide a visual estimate of the percentage of the webpage that has been downloaded.

4. The computer readable storage medium of claim 3, wherein visually modifying the user interface element responsive to storing the portion of the web page comprises:
modifying a background shading or coloring of the user interface element to fill the user interface element as the web page is downloaded.

5. The computer readable storage medium of claim 3, wherein visually modifying the user interface element responsive to storing the portion of the web page comprises:
displaying a progress indicator within the user interface element; and
visually modifying the progress indicator as the web page is downloaded.

6. A method for regulating receipt of content by a mobile computing device:
generating a status indicator;
determining whether content is being received;
responsive to receiving an interaction with the status indicator while content is being received, stopping receipt of the content; and
responsive to receiving an interaction with the status indicator after content has been received, transmitting a request to update the content that has been received.

7. The method of claim 6, wherein determining whether content is being received comprises:
responsive to determining content is being received, modifying the status indicator to visually indicate content is being received; and
responsive to determining content has been received, modifying the status indicator to visually indicate content has been received.

8. The method of claim 6, wherein modifying the status indicator to visually indicate content is being received comprises:
displaying a symbol or text associated with stopping retrieval of content.

9. The method of claim 8, wherein modifying the status indicator to visually indicate content is being received further comprises:
displaying a progress indicator describing an amount of content that has been received relative to a total amount of content.

10. The method of claim 7, wherein modifying the status indicator to visually indicate content has been received comprises:
displaying a symbol or text associated with updating content.

11. A computer readable storage medium configured to store instructions, the instructions when executed by a processor cause the processor to execute the steps of:
generating a status indicator;
determining whether content is being received;
responsive to receiving an interaction with the status indicator while content is being received, stopping receipt of the content; and
responsive to receiving an interaction with the status indicator after content has been received, transmitting a request to update the content that has been received.

12. The computer readable storage medium of claim 11, wherein determining whether content is being received comprises:
responsive to determining content is being received, modifying the status indicator to visually indicate content is being received; and
responsive to determining content has been received, modifying the status indicator to visually indicate content has been received.

13. The computer readable storage medium of claim 12, wherein modifying the status indicator to visually indicate content is being received comprises:
displaying a symbol or text associated with stopping retrieval of content.

14. The computer readable storage medium of claim 13, wherein modifying the status indicator to visually indicate content is being received further comprises:
displaying a progress indicator describing an amount of content that has been received relative to a total amount of content.

15. The computer readable storage medium of claim 12, wherein modifying the status indicator to visually indicate content has been received comprises:
displaying a symbol or text associated with updating content.
